(19) United States
(12) Patent Application Publication
(10) Pub. No.: US 2024/0369073 A1
(43) Pub. Date: Nov. 7, 2024

(54) AIR-HEATED GUIDE VANE WITH TIP HEATING

(71) Applicant: General Electric Company Polska Sp. z o.o., Warsaw (PL)

(72) Inventors: Dariusz Olczak, Warsaw (PL); Maciej Stanczyk, Warsaw (PL); Damian Owczarek, Warsaw (PL); Adam Tomasz Pazinski, Warsaw (PL)

(21) Appl. No.: 18/354,005

(22) Filed: Jul. 18, 2023

(30) Foreign Application Priority Data
May 4, 2023 (PL) P.444740

(51) Int. Cl. F04D 29/58; F01D 9/06; F04D 29/54

(52) U.S. Cl. CPC F04D 29/582; F01D 5/18; F01D 9/065; F01D 25/02; F02C 7/047; F04D 29/542; F05D 2220/3216

(57) ABSTRACT

An inlet guide vane for use in a gas turbine engine may include an internal cavity for receipt of an anti-ice air to discourage build-up of ice in a flow path of the gas turbine engine. The inlet guide vane can include an anti-ice flow passage formed in a tip of the inlet guide vane which receives the anti-ice air from the internal cavity prior to being discharged from the inlet guide vane. Anti-ice air can be discharged through a tip of the inlet guide vane, through a leading edge of the inlet guide vane, or into a shaft side passage provided in a component defining the inner flow surface. In another form, anti-ice air can be provided from a sump of the gas turbine engine, through a shaft side passage, and into the inlet guide vane before being discharged.

### PRIORITY INFORMATION

The present application claims priority to Polish Patent Application Number P.444740 filed on May 4, 2023.

### FIELD

The present disclosure relates to a guide vane for a turbine engine and a turbine engine including the same.

### BACKGROUND

A gas turbine engine generally includes a turbomachine having a rotor assembly. Gas turbine engines, such as turbofan engines, may be used for aircraft propulsion, and in that regard may be subjected to in-flight icing conditions. In the event that icing conditions are present, ice buildup may occur in a flow path of the gas turbine engine, such as but not limited to the guide vanes of a compressor section of the gas turbine engine. A method of preventing ice formation in the flowpath is the use of air-heated flowpath components, where hot air is used to raise the component temperature to acceptable levels. In general, it is desirable to prevent ice build-up from occurring to prevent engine damage, ensure continued engine operation, and preserve engine operating margin as well as performance.

### BRIEF DESCRIPTION OF THE DRAWINGS

A full and enabling disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a view of a prior art guide vane structured to be heated with anti-ice air.

FIG. 3 is a schematic view of an inlet guide vane with anti-ice air provided to a tip of the inlet guide vane in accordance with another exemplary aspect of the present disclosure.

FIG. 4 is a schematic view of another inlet guide vane with anti-ice air provided to a tip of the inlet guide vane in accordance with another exemplary aspect of the present disclosure.

FIG. 5A is a schematic view of yet another inlet guide vane with anti-ice air provided to a tip of the inlet guide vane in accordance with another exemplary aspect of the present disclosure.

FIG. 5B is a schematic view of yet another inlet guide vane with anti-ice air provided to a tip of the inlet guide vane in accordance with another exemplary aspect of the present disclosure.

FIG. 6 is a schematic view of still another inlet guide vane with anti-ice air provided to a tip of the inlet guide vane in accordance with another exemplary aspect of the present disclosure.

FIG. 7 is a schematic view of a further inlet guide vane with anti-ice air provided to a tip of the inlet guide vane in accordance with another exemplary aspect of the present disclosure.

FIG. 8 is a schematic view of still another inlet guide vane with anti-ice air provided to a tip of the inlet guide vane in accordance with another exemplary aspect of the present disclosure.

FIG. 9 is a schematic view of a controller useful to regulate a value to control a flow of anti-ice air to an inlet guide vane in accordance with an exemplary aspect of the present disclosure.

FIG. 10 is a flow chart describing a method for providing anti-ice air to a compressor section of a gas turbine engine in accordance with the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “axial” and “axially” refer to directions and orientations that extend substantially parallel to a reference axis. Moreover, the terms “radial” and “radially” refer to directions and orientations that extend substantially perpendicular to the reference axis. In addition, as used herein, the terms “circumferential” and “circumferentially” refer to directions and orientations that extend arcuately about the reference axis.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “first”, “second”, and “third” may be used interchangeably to distinguish one component from another and are not intended to signify location or importance of the individual components.

A “third stream” as used herein means a non-primary air stream capable of increasing fluid energy to produce a minority of total propulsion system thrust. The third stream may generally receive inlet air (air from a ducted passage downstream of a primary fan) instead of freestream air (as the primary fan would). A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

As will be discussed in more detail below, the subject matter of the present disclosure is directed generally to an inlet guide vane, such as an inlet guide vane to a compressor of a gas turbine engine, capable of having anti-ice air provided to it for purposes of discouraging formation of ice in a flow path of the engine. The anti-ice air can originate from any suitable location in the gas turbine engine, including, but not limited to, a high pressure compressor. The inlet guide vane can include an internal passage routed to a tip region that includes an anti-ice flow passage oriented to discharge the anti-ice air toward an inner flow surface of an annular flow path within which the inlet guide vane is located. The anti-ice flow passage can include a flow port through which the anti-ice air is discharged. In one form, the anti-ice air is discharged with sufficient energy to impinge on the inner flow surface of the annular flow path. The anti-ice air can be discharged through a flow port at the tip edge toward the inner flow path surface, or through flow ports on the leading edge. In another form, the anti-ice air can exit the inlet guide vane into a shaft side passage defined in a component forming the inner flow path surface of the annular flow path. The anti-ice air can be routed to a shaft side cavity to aid in warming the structure to discourage formation of ice. In yet another form, the anti-ice air can be discharged back through an outlet port provided in a component defining the inner flow surface of the annular flow path. In still yet another form, anti-ice air can be provided from a sump of the gas turbine engine, through a shaft side passage, and into the inlet guide vane before being discharged.

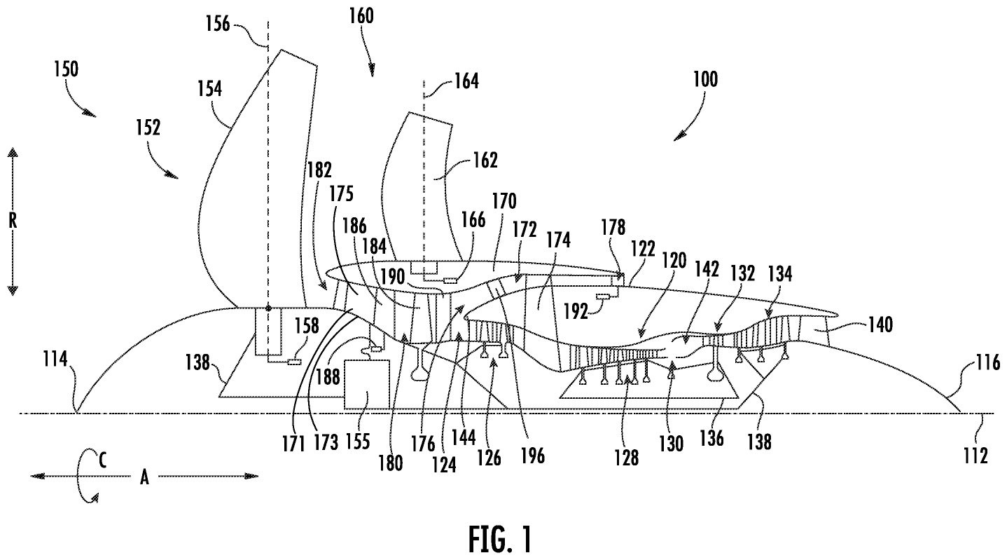

Referring now to FIG. 1, a schematic cross-sectional view of a gas turbine engine 100 is provided according to an example embodiment of the present disclosure. Particularly, FIG. 1 provides a turbofan engine having a rotor assembly with a single stage of unducted rotor blades. In such a manner, the rotor assembly may be referred to herein as an “unducted fan,” or the entire engine 100 may be referred to as an “unducted turbofan engine.” In addition, the gas turbine engine 100 of FIG. 1 includes a third stream extending from the compressor section to a rotor assembly flowpath over the turbomachine, as will be explained in more detail below.

Though the embodiment of FIG. 1 illustrates a unducted turbofan engine, it will be appreciated that other types of gas turbine engines are contemplated herein for the discussion that follows. For example, it will be understood that turbojet engines, ducted turbofan engines, turboprop engines, gas turbine engines with centrifugal compressors, etc. are all contemplated for use with the various embodiments of inlet guide vanes depicted herein. No limitation is intended unless otherwise required as to the type of gas turbine engines useful with the inlet guide vanes described herein.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The HP turbine 132 drives the HP compressor 128 through a high pressure shaft 136. In this regard, the HP turbine 132 drives the HP compressor 128. The high energy combustion products then flow to a low pressure turbine 134. The LP turbine 134 drives the LP compressor 126 and components of the fan section 150 through a low pressure shaft 138. In this regard, the LP turbine 134 drives the LP compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the gas turbine engine 100 may be referred to as an open rotor or open fan engine.

As depicted, the fan 152 includes an array of fan blades 154 (only one shown in FIG. 1). The fan blades 154 are rotatable, e.g., about the longitudinal axis 112. As noted above, the fan 152 is driven by the low pressure turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween, and more specifically defines a tip radius R_{TIP} from the longitudinal axis 112 to the tips of the fan blades 154 along the radial direction R. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes an outlet guide vane array 162 that includes outlet guide vanes 162 (only one shown in FIG. 1; sometimes also referred to as fan guide vanes) disposed around the longitudinal axis 112. For this embodiment, the outlet guide vanes 162 are not rotatable about the longitudinal axis 112. Each outlet guide vane 162 has a root and a tip and a span defined therebetween. The outlet guide vanes 162 may be unshrouded as shown in FIG. 1 or, alternatively, may be shrouded, e.g., by an annular shroud spaced outward from the tips of the outlet guide vanes 162 along the radial direction R or attached to the outlet guide vanes 162.

As will be appreciated, the outlet guide vanes 162 each define an outlet guide vane (OGV) span 164 along the radial direction R from a root to a tip. Additionally, the outlet guide vanes 162 are spaced from the fan blade 154 along the axial direction A by a distance or spacing 166. The spacing 166 is measured from an aft-most edge of the fan blade 154 to a forward-most edge of the outlet guide vanes 162 along the axial direction A.

In the embodiment depicted, as noted above, each outlet guide vane 162 is configured as a fixed guide vane, unable to be pitched about a central blade axis of the outlet guide vane 162. The outlet guide vanes 162 are thus mounted to a fan cowl 170 in a fixed manner.

It will be appreciated, however, that in other embodiments, the outlet guide vanes 162 may alternatively be variable pitch outlet guide vanes 162.

As shown in FIG. 1, in addition to the fan 152, which is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the low pressure turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the gas turbine engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing through the fan duct 172. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The gas turbine engine 100 also defines or includes an inlet duct 180. The inlet duct 180 extends between the engine inlet 182 and the core inlet 124/fan duct inlet 176. The engine inlet 182 is defined generally at the forward end of the fan cowl 170 and is positioned between the fan 152 and the outlet guide vane array 160 along the axial direction A. The inlet duct 180 is an annular duct forming an annular flow path 171 that is positioned inward of the fan cowl 170 along the radial direction R. The annular flow path 171 includes an inner flow surface 173 and an outer flow surface 175, where the inner flow surface 173 is radially inward from the outer flow surface 175 such that the inner flow surface 173 is on a shaft side of the annular flow path 171 (e.g., the inner flow surface 173 is closer to the LP shaft 138 than the outer flow surface 175). Air flowing downstream along the inlet duct 180 is split, not necessarily evenly, into the core duct 142 and the fan duct 172 by a fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the gas turbine engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). In particular, the gas turbine engine 100 further includes an array of inlet guide vanes 186 positioned in the inlet duct 180 upstream of the ducted fan 184 and downstream of the engine inlet 182. As will be appreciated, the inlet guide vanes 186 can be used to maintain operability of the compressor. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the gas turbine engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the gas turbine engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the gas turbine engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 198 may be positioned in thermal communication with the fan duct 172. For example, one or more heat exchangers 198 may be disposed within the fan duct 172 and utilized to cool one or more fluids from the core engine with the air passing through the fan duct 172, as a resource for removing heat from a fluid, e.g., compressor bleed air, oil or fuel.

Although not depicted, the heat exchanger 198 may be an annular heat exchanger extending substantially 360 degrees in the fan duct 172 (e.g., at least 300 degrees, such as at least 330 degrees). In such a manner, the heat exchanger 198 may effectively utilize the air passing through the fan duct 172 to cool one or more systems of the gas turbine engine 100 (e.g., lubrication oil systems, compressor bleed air, electrical components, etc.). The heat exchanger 198 uses the air passing through duct 172 as a heat sink and correspondingly increases the temperature of the air downstream of the heat exchanger 198 and exiting the fan exhaust nozzle 178.

It will be appreciated, that for the purposes of discussion in the present disclosure, the ducted fan 184, the fan cowl 170, the inlet duct 180, and the fan duct 172 may all be considered part of the turbomachine 120.

It will be appreciated that the exemplary gas turbine engine 100 depicted in FIG. 1 (depicted as a turbofan) is provided by way of example only, and that in other embodiments, the gas turbine engine 100 may have any other suitable configuration. For example, in other embodiments, the gas turbine engine 100 may not include the fan duct 172/third stream, and as such may be configured as a “two stream” engine. Additionally, or alternatively, in other embodiments, the gas turbine engine 100 may be configured as a direct drive engine (e.g., without the gearbox 155), as a fixed-pitch engine (e.g., without the actuator 158), etc.

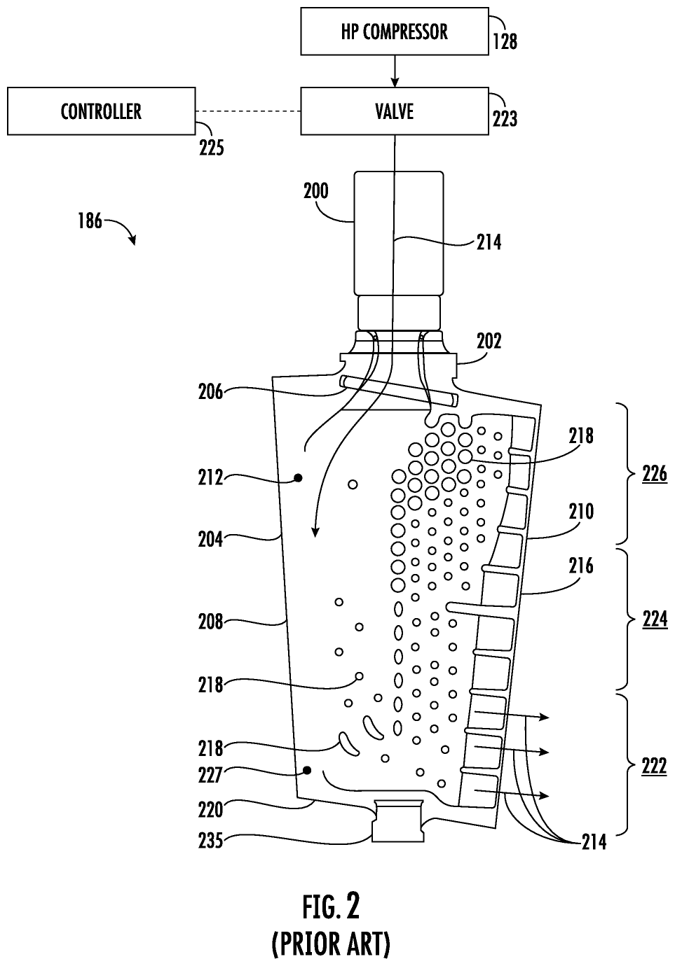

Turning now to FIG. 2, a prior art form of an inlet guide vane 186 is depicted in which the inlet guide vane 186 includes a spindle 200 about which the inlet guide vane 186 can be rotated, an outer button 202, and airfoil section 204. The shroud can include a surface 206 used with other components to form the outer flow surface 175 of the annular flow path 171. The airfoil section 204 includes a leading edge 208 and a trailing edge 210. The inlet guide vane 186 includes an internal cavity 212 through which an anti-ice air can be routed. After passing into the cavity 212 from a passage in the spindle the anti-ice air can be discharged through a slot, hole, or other suitable discharge port 216 at the trailing edge 210 of the inlet guide vane 186. The anti-ice air 214 can be routed through the spindle 200 from any suitable location capable of providing air that is at a relatively high pressure and high temperature, sufficient to provide air for anti-ice purposes and also sufficient energy to exit the inlet guide vane 186 through the discharge port. For example, the anti-ice air 214 can be delivered from the HP compressor 128 via a valve 223. The valve 223 can be regulated by a controller 225 to control the state of delivery and/or the rate of delivery of the anti-ice air 214 to the inlet guide vane 186. In some forms the controller 225 is able to detect potential icing conditions and activate the valve 223 to supply anti-ice air 214 to the inlet guide vane 186. Alternatively and/or additionally, the controller 225 can activate the valve 223 based on pilot input. Still further, in some embodiments the controller 225 and valve 223 may not be present, and instead anti-ice air is routed to the inlet guide vane 186 through fluid momentum and/or pressure differential.

Also depicted in FIG. 2 are various internal features 218 that can provide structural support for the airfoil section 204 and/or provide fluidic interaction with the anti-ice air. Fluidic interactions can include fluid directors, turbulators, and guides to direct fluid through the cavity, provide mixing of the air to promote heat transfer, etc.

In addition to the leading edge 208 and trailing edge 210, the inlet guide vane 186 also include a tip edge 220 located in the tip region 222 near the end of the airfoil section 204. As will be appreciated, the tip edge can be located at the tip of the guide vane 186 which is located on neither the pressure side nor the suction side, and does not form either the leading edge or the trailing edge. The tip region 222 occupies a space located over about a third of the span of the airfoil section 204 closest to and including the tip edge 220, where span can be measured in a radial direction away from the root. The tip region 222 is contrasted with the root region 226 which is located in about a third of the span of the airfoil section 204 closest to and including the root near the surface 206. A mid-span region 224 occupies about a third of the span between the root region 226 and the tip region 222. Each of the root region 226, mid-span region 224, and tip region 222 are located to extend across the flow path 171.

In the guide vane 186 depicted in FIG. 2, a region 227 can be located in the internal cavity 212 near the leading edge 208 characterized by recirculating and/or stagnating flow which reduces the effectiveness of the anti-ice air 214 to prevent icing in the tip region 222.

Also depicted in FIG. 2 is a button 235 useful to locate the guide vane 186 with an adjacent engine component to fix the guide vane 186 into position. In some forms, the button 235 can also form a bearing surface to permit relative rotation of the guide vane 186. In some forms, the button 235 is integral with the guide vane 186 and extends past the portion of the guide vane 186 located adjacent to a flow path surface wall.

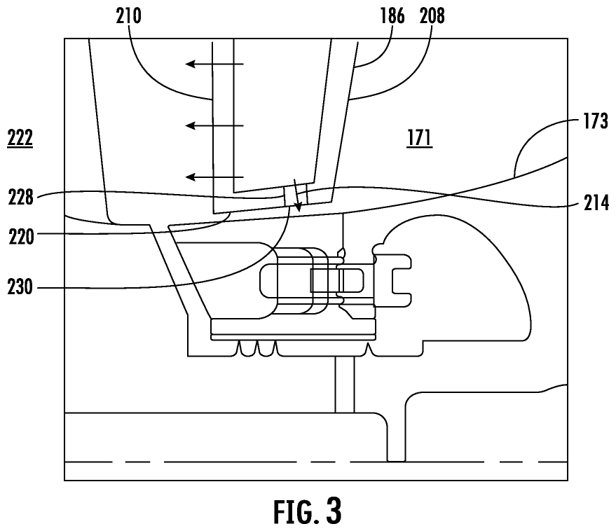

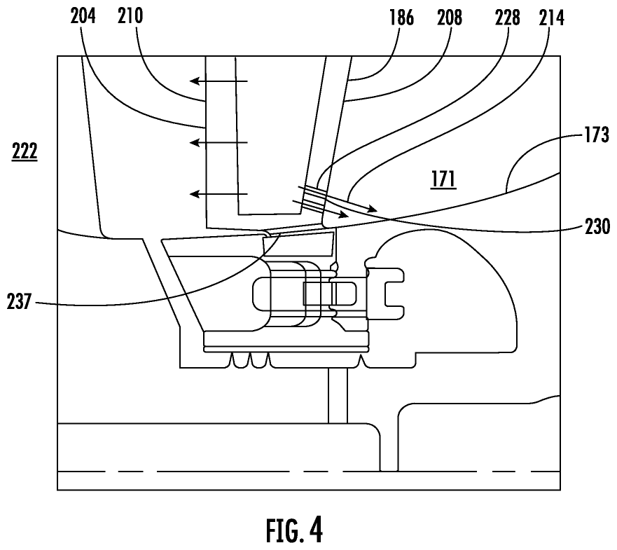

Turning now to FIG. 3, an embodiment of the inlet guide vane 186 of the instant application can additionally include an anti-ice flow passage 228 oriented to discharge anti-ice air 214 through a flow port 230 at the tip edge 220 in a direction substantially radially inward toward the inner flow surface 173. Such a flow path that progresses radially from the root region 226 and through the tip region 222 promotes more effective heat transfer and therefore discourages formation of ice in the tip region 222 that is possible in the guide vane 186 of FIG. 2. In other words, the recirculating and/or stagnation region 227 in FIG. 2 is ameliorated by the flow-through configuration of the embodiment depicted in FIG. 3 (as well as the flow-through configurations of FIGS. 4-7 depicted further below) such as to keep the internal flow energized along the entire leading edge of the guide vane 186. In addition, a gap between the tip edge 220 and the inner flow surface 173 of FIG. 3 can be such that the energy of the flow of anti-ice air 214 can impinge upon the inner flow surface 173 or otherwise flow in close enough proximity to discourage formation of ice. For example, the interaction of the working fluid through the annular flow path 171 and the discharged anti-ice air 214 may permit impingement of the anti-ice air 214 to form a stagnation streamline on the inner flow surface 173, but in other embodiments such impingement or other sufficient interaction creates a region of flow mixing to a degree to discourage formation of ice. The flow port 230 can take on any number of configurations, including any number of cross-sectional shapes and areas. In one form, the flow port 230 is circular in shape, while in another it can be a slot configuration, to set forth just two non-limiting examples. Further, the flow port 230 can be located at any chord location along the tip edge. In some embodiments, the inlet guide vane 186 can include two or more flow ports 230. Given the complementary shape of the tip edge 220 to the inner flow surface 173, the orientation of the anti-ice air 214 can have an axial directional component, but it will be appreciated that the predominate directional component is radial. Still further, though the direction of the anti-ice air 214 can be orthogonal to the inner flow surface 173, in some forms the direction can be at an angle to the inner flow surface 173. The anti-ice flow passages 228 are oriented to discharge anti-ice air 214 through a flow port 230 in a direction substantially radially inward toward the inner flow surface 173.

FIG. 4 discloses an additional exemplary embodiment of the inlet guide vane 186 having a plurality of anti-ice flow passages 228 positioned in the tip region 222 and located at the leading edge 208 of the airfoil section 204. The anti-ice flow passages 228 are oriented to discharge anti-ice air 214 from the leading edge 208 and through respective flow ports 230. The anti-ice flow passages 228 are oriented to include a radially inward directional component toward the inner flow surface 173, as well as an axially forward directional component (e.g., oriented in an upstream direction relative to the flow of working fluid through the annular flow path 171) such that the anti-ice air 214 is discharged in an upstream direction and against a direction of a working fluid in the annular flow path 171. Discharge of the anti-ice air 214 through the flow ports 230 can be such that the energy of the flow of anti-ice air 214 can impinge upon the inner flow surface 173 or otherwise flow in close enough proximity to discourage formation of ice. For example, the interaction of the working fluid through the annular flow path 171 and the discharged anti-ice air 214 may permit impingement of the anti-ice air 214 to form a stagnation streamline on the inner flow surface 173, but in other embodiments, such impingement or other sufficient interaction creates a region of flow mixing to a degree to discourage formation of ice. The inner flow surface 173 in proximity to the flow ports 230 can thus be warmed, and surrounding areas of the inner flow surface 173 as well, to such a degree as to discourage formation of ice. The flow ports 230 can take on any number of configurations, including any number of cross-sectional another inlet guide vane with anti-ice air provided to a tip of the inlet guide vane in accordance with another exemplary aspect of the present disclosure shapes and areas. In one form, the flow ports 230 are circular in shape, while in another the flow ports 230 can be in a slot configuration, to set forth just two non-limiting examples. In some embodiments, the inlet guide vane 186 can include fewer or greater numbers of flow ports 230 at the leading edge 208.

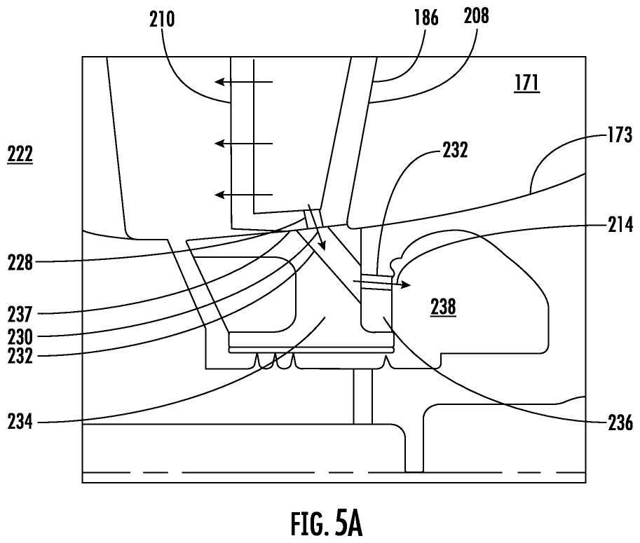

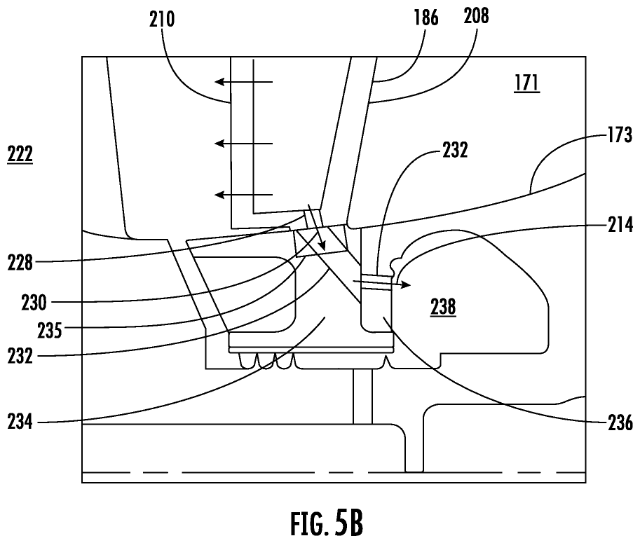

FIG. 5A discloses an additional exemplary embodiment of the inlet guide vane 186 in which an anti-ice flow passage 228 in the tip region 222 is configured to deliver anti-ice air 214 into a shaft side passage 232 formed in a component 234 that is used at least in part to define the inner flow surface 173 of the annular flow path 171. The inlet guide vane 186 can include a protrusion 237 located at the tip to improve mechanical engagement between the guide vane 186 and the component 234 and to discourage leakage of the anti-ice air 214 at the intersection of the inlet guide vane 186 and the component 234. As will be appreciated, the protrusion 237 at the tip may not extend entirely from the leading edge to the trailing edge and thus a gap can nevertheless still be formed between the inlet guide vane 186 and the component 234. In one embodiment, the protrusion 237 can take the form of a button, such as the button 235 depicted in FIG. 2, and the component 234 may have a larger recess used to receive the button (see FIG. 5B which illustrates the shaft side passage formed through the button 235). In still another embodiment, the inlet guide vane 186 may include the structure depicted in FIG. 5 labelled as component 234 radially inward from the inner flow surface 173 such that the anti-ice flow passage 228 is integral with the shaft side passage 232. The shaft side passage 232 can take on any variety of forms, have any variety of lengths, and have any variety of cross-sectional shapes. In the illustrated embodiment, the shaft side passage 232 is also formed in another component 236, but not all embodiments of the inlet guide vane 186 need include a shaft side passage 232 in a plurality of components. In the illustrated embodiment, the shaft side passage 232 is used to deliver anti-ice air 214 to a location forward (e.g., in a direction that extends away from the trailing edge 210 and toward the leading edge 208) of the inlet guide vane 186. Other embodiments, however, may include routing the anti-ice air 214 to other locations. The anti-ice air 214 can be delivered to a shaft side cavity 238 which can be used to warm the material of the inner flow surface 173 in proximity to the shaft side cavity 238 and discourage formation of ice on the inner flow surface 173 in that region. The shaft side cavity 238 can be located forward of the leading edge 208 of the inlet guide vane 186, and in some embodiments can extend circumferentially to a location forward of a neighboring inlet guide vane 186 to aid in warming the inner flow surface 173 in those locations to discourage formation of ice.

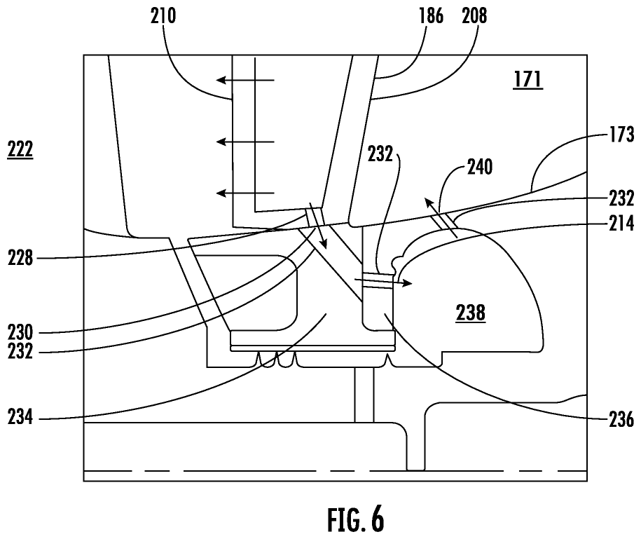

FIG. 6 illustrates an embodiment using the shaft side passages 232 of FIG. 5 to deliver anti-ice air 214 to an outlet port 240 formed in the inner flow surface 173 defined by the component 236 and located upstream from the inlet guide vane 186. The outlet port 240 can take a variety of forms and cross-sectional shapes. For example, in one form, the outlet port 240 can be a plurality of circular openings, while in another it may be a slot configuration. Furthermore, the outlet port 240 can emit anti-ice air 214 in any variety of directions. In the illustrated embodiment, the outlet port 240 discharges the anti-ice air 214 at an angle to the inner flow surface 173 such that the angle includes a directional component in the downstream direction. In other embodiments, however, the outlet port 240 may discharge anti-ice air 214 having a directional component in the upstream direction or perpendicular to the flow. Though only one outlet port 240 is illustrated in FIG. 6, other embodiments can include additional outlet ports 240, whether located immediately forward of the leading edge 208 or distributed circumferentially to locations near neighboring inlet guide vanes 186.

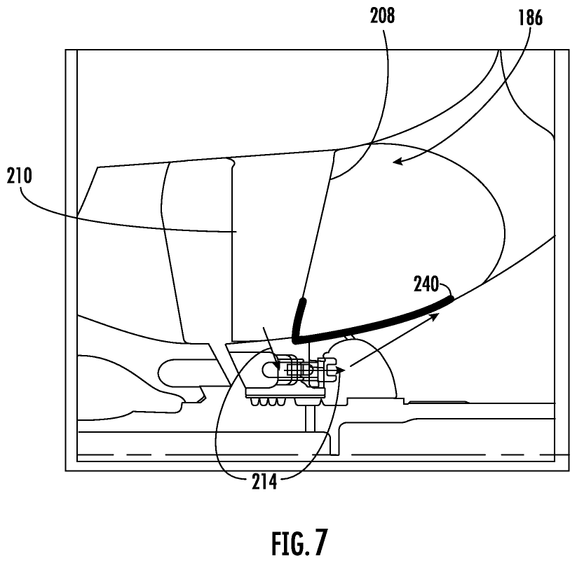

FIG. 7 is a simplified schematic of a variation of the embodiment depicted in FIG. 6 in which the outlet port 240 has been moved relative to the position indicated in FIG. 6 to a location further upstream of the inlet guide vane 186 having the trailing edge 210 and leading edge 208. As above, the outlet port 240 can take a variety of forms and cross-sectional shapes. For example, in one form, the outlet port 240 can be circular, while in another it may be a slot configuration. Furthermore, the outlet port 240 can emit anti-ice air 214 in any variety of directions. In the illustrated embodiment, the outlet port 240 discharges the anti-ice air 214 at an angle to the inner flow surface 173 such that the angle includes a directional component in the upstream direction. In other embodiments, however, the outlet port 240 may discharge anti-ice air 214 having a directional component in the downstream direction. Though only one outlet port 240 is illustrated in FIG. 7, other embodiments can include additional outlet ports 240, whether located forward of the leading edge 208 or distributed circumferentially to locations near neighboring inlet guide vanes 186.

With respect to the distance upstream from the leading edge 208 at which the outlet port 240 is located in the embodiment of FIG. 7, it is contemplated that the outlet port 240 can be located anywhere within four chord lengths of the leading edge 208. The chord length is generally understood as the distance between the leading edge 208 and the trailing edge 210 of the inlet guide vane 186. In cases of highly cambered airfoil sections 204, the chord length can be the straight-line distance between the points of the camber line associated with the leading edge and trailing edge. The chord length can also be determined by a mean aerodynamic chord or the average chord length in cases of tapered and/or swept airfoil sections 204. Any suitable measure of chord is contemplated.

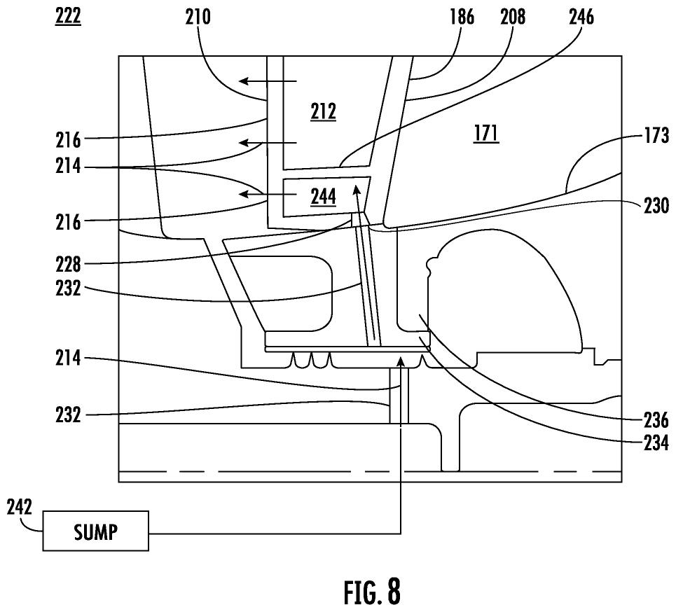

FIG. 8 depicts an exemplary embodiment of the inlet guide vane 186 in which an anti-ice flow passage 228 in the tip region 222 is configured to receive anti-ice air 214 from a shaft side passage 232 formed in a component 234 that is used at least in part to define the inner flow surface 173 of the annular flow path 171. The inlet guide vane 186 can include a button 235 located at the tip to engage with the component 234 to discourage leakage of the anti-ice air 214 at the intersection of the inlet guide vane 186 and the component 234. The button 235 can be a protrusion of the inlet guide vane 186 formed to close a gap between the inlet guide vane 186 and the component 234. In one embodiment, the button 235 can take the form of a vane extension, and the component 234 may have a larger recess used to receive the vane extension. In still another embodiment, the inlet guide vane 186 may include the structure depicted in FIG. 8 labelled as component 234 positioned radially inward from the inner flow surface 173 such that the anti-ice flow passage 228 is integral with the shaft side passage 232. The shaft side passage 232 can take on any variety of forms, have any variety of lengths, and have any variety of cross-sectional shapes. In the illustrated embodiment, the shaft side passage 232 is also formed in another component 236, but not all embodiments of the inlet guide vane 186 need include a shaft side passage 232 in a plurality of components. In the illustrated embodiment, the shaft side passage 232 is used to deliver anti-ice air 214 from a sump 242 of the gas turbine engine 100. As will be appreciated, the flow of anti-ice air 214 from the sump 242 may not be regulated as above with respect to regulation of anti-ice air 214 in FIG. 2 above, and may instead be delivered at a rate, temperature, and pressure commensurate with an operating condition of the gas turbine engine 100. In some embodiments, the flow of anti-ice air 214 from the sump 242 can be part of a circuit separate from the circuit depicted above with respect to FIG. 2. The anti-ice air 214 routed through the shaft side passage 232 and into the anti-ice flow passage 228 can be received in a tip cavity 244 of the inlet guide vane 186. The anti-ice air 214 can be used to warm the tip region 222 of the inlet guide vane 186 to discourage the formation of ice. The tip cavity 244 is in further communication with the discharge port 216 located at the trailing edge 210 of the inlet guide vane 186. As above, the discharge port 216 can take on a variety of forms, shapes, and sizes. The tip cavity 244 can be separated from the internal cavity 212 by a dam 246 used to segregate the flow of anti-ice air 214.

Several embodiments above are capable of being combined with others. For example, FIG. 4 can be combined with any of FIGS. 5-7. As another example, the flow ports provided in FIGS. 3 and 4 can be applied to the embodiment in FIG. 8. Furthermore, although the embodiments described in FIGS. 2-8 relate to an inlet guide vane 186, the disclosure herein can also be applied to other guide vanes, such as, but not limited to, outlet guide vane 162.

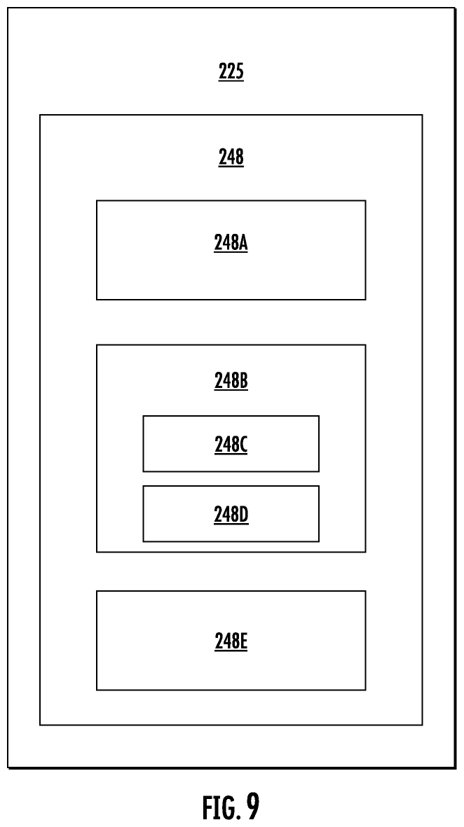

Turning now to FIG. 9, the controller 225 can be implemented using a computing device 248, one embodiment of which is illustrated in FIG. 9. The computing device(s) 248 can include one or more processor(s) 248A and one or more memory device(s) 248B. The one or more processor(s) 248A can include any suitable processing device, such as a microprocessor, microcontroller, integrated circuit, logic device, and/or other suitable processing device. The one or more memory device(s) 248B can include one or more computer-readable media, including, but not limited to, non-transitory computer-readable media, RAM, ROM, hard drives, flash drives, and/or other memory devices.

The one or more memory device(s) 248B can store information accessible by the one or more processor(s) 248A, including computer-readable instructions 248C that can be executed by the one or more processor(s) 248A. The instructions 248C can be any set of instructions that when executed by the one or more processor(s) 248A, cause the one or more processor(s) 248A to perform operations. In some embodiments, the instructions 248C can be executed by the one or more processor(s) 248A to cause the one or more processor(s) 248A to perform operations, such as any of the operations and functions for which the controller and/or the computing device(s) 248 are configured, the operations for any of the aforementioned systems such as the valve 223, etc., as described herein, and/or any other operations or functions of the one or more computing device(s) 248 (e.g., as a full authority digital engine controller). The instructions 248C can be software written in any suitable programming language or can be implemented in hardware. Additionally, and/or alternatively, the instructions 248C can be executed in logically and/or virtually separate threads on the one or more processor(s) 248A. The one or more memory device(s) 248B can further store data 248D that can be accessed by the one or more processor(s) 248A. For example, the data 248D can include data indicative of outside air conditions, power flows, data indicative of engine/aircraft operating conditions, and/or any other data and/or information described herein.

The computing device(s) 248 can also include a network interface 248E used to communicate, for example, with the other components of the systems described herein (e.g., via a communication network). The network interface 248E can include any suitable components for interfacing with one or more network(s), including for example, transmitters, receivers, ports, controllers, antennas, and/or other suitable components. One or more devices can be configured to receive one or more commands from the computing device(s) 248 or provide one or more commands to the computing device(s) 248.

The network interface 248E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or a plurality of computing devices working in combination. Databases, memory, instructions, and applications can be implemented on a single system or distributed across a plurality of systems. Distributed components can operate sequentially or in parallel.

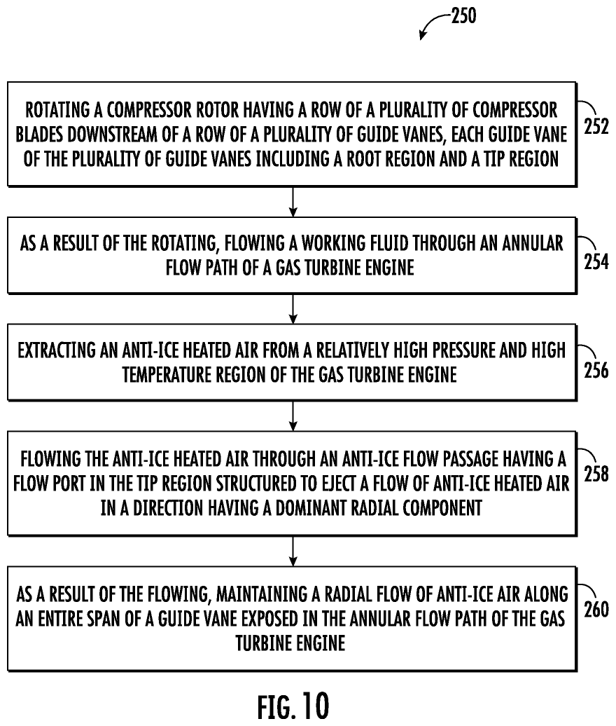

FIG. 10 discloses a method 250 for providing anti-ice air to a compressor section (e.g., LP compressor 126) of a gas turbine engine 100 which includes at step 252 of rotating a compressor rotor having a row of a plurality of compressor blades (e.g., fan blades 184 are one non-limiting form of a compressor blade, with other suitable compressor blades found in the LP compressor 126 and/or HP compressor 128) downstream of a row of a plurality of guide vanes (e.g., vanes 186, with other suitable guide vanes found in the LP compressor 126 and/or HP compressor 128). It will be appreciated herein the reference to “compressor blades” can refer to circumferential arrangements of axial compressor blades used in axial flow compressors, as well as circumferential arrangements of centrifugal compressor blades used on the face of impellers in centrifugal flow compressors. Each guide vane 186 of the plurality of guide vanes including a root region 226 and a tip region 222. As a result of the rotating from step 252, step 254 includes flowing a working fluid through an annular flow path 171 of the gas turbine engine 100. Step 256 includes extracting an anti-ice air 214 from a relatively high pressure and high temperature region of the gas turbine engine 100. Step 258 includes flowing the anti-ice air 214 through an anti-ice flow passage 228 having a flow port 230 in the tip region 222 structured to eject a flow of anti-ice air 214 in a direction having a dominant radial component. As a result of step 258, step 260 includes maintaining a radial flow of anti-ice air in the internal cavity along an entire span of the guide vane exposed in the annular flow path of the gas turbine engine.

Further aspects are provided by the subject matter of the following clauses:

An anti-ice system to provide anti-ice air to a compressor section of a gas turbine engine, the anti-ice system comprising: a flow path defined in the compressor section of the gas turbine engine, the flow path defined between an inner flow surface and an outer flow surface, the flow path structured to convey a working fluid; a plurality of compressor blades arranged in a row and disposed in the flow path, the plurality of compressor blades configured to rotate to compress the working fluid; and a plurality of guide vanes arranged in a row and disposed in the flow path upstream of the plurality of compressor blades, each guide vane of the plurality of guide vanes extending from a root region to a tip region across the flow path, the root region and the tip region located in the flow path, the plurality of guide vanes each having an internal cavity and an anti-ice flow passage located at the tip region between the internal cavity and an outer surface of each respective guide vane of the plurality of guide vanes, the anti-ice flow passage having a flow port structured to eject a flow of the anti-ice air, the anti-ice flow passage oriented in a direction having a radial component such that the anti-ice air is flowed in a substantially radial direction through the internal cavity over an entirety of the tip region exposed in the flow path.

The anti-ice system of one or more of these clauses, wherein the anti-ice air is routed from the root region of each guide vane of the plurality of guide vanes to a respective tip region of the guide vane.

The anti-ice system of one or more of these clauses, wherein the internal cavity extends from the root region of each guide vane of the plurality of guide vanes to a respective tip region of the guide vane, and wherein the anti-ice air is conveyed from the root region to the tip region by the internal cavity.

The anti-ice system of one or more of these clauses, wherein each guide vane of the plurality of guide vanes includes a leading edge, a trailing edge, and a tip edge having a contour sized to match a contour of an adjacent portion of the inner flow surface of the flow path, the flow port oriented to impinge the anti-ice air against the adjacent portion of the inner flow surface.

The anti-ice system of one or more of these clauses, wherein the inner flow surface is defined by a component having a shaft side passage; and the plurality of guide vanes each having the internal cavity and the anti-ice flow passage located between the internal cavity and an outer surface of each respective guide vane of the plurality of guide vanes, the flow port structured to eject a flow of the anti-ice air, the anti-ice flow passage located proximate the shaft side passage and oriented in a direction having a radial component to convey the anti-ice air onward to the shaft side passage of the component of the inner flow surface and to a region radially inward of the inner flow surface.

The anti-ice system of one or more of these clauses, wherein the inner flow surface is defined by a component having a shaft side passage; and the plurality of guide vanes each having the internal cavity and the anti-ice flow passage located between the internal cavity and the outer surface of each respective guide vane of the plurality of guide vanes, the flow port structured to eject the flow of the anti-ice air, the anti-ice flow passage located proximate the shaft side passage and oriented to convey the anti-ice air onward to the shaft side passage of the component of the inner flow surface and to a region radially inward of the inner flow surface.

The anti-ice system of one or more of these clauses, wherein each guide vane of the plurality of guide vanes includes a button, and wherein the anti-ice flow passage is formed in the button.

The anti-ice system of one or more of these clauses, wherein the shaft side passage is oriented in a direction that includes an axial component, the axial component directed in an upstream direction, the shaft side passage delivering anti-ice air to an upstream location of the inner flow surface.

The anti-ice system of one or more of these clauses, wherein an outlet port is located at the upstream location, and wherein the outlet port is configured to emit the anti-ice air into the flow path in a downstream direction.

The anti-ice system of one or more of these clauses, wherein the inner flow surface includes an outlet port located upstream from the shaft side passage in the flow path.

The anti-ice system of one or more of these clauses, wherein each guide vane of the plurality of guide vanes is associated with a respective outlet port.

The anti-ice system of one or more of these clauses, wherein the outlet port includes a plurality of outlet ports associated with a plurality of shaft side passages in each of the plurality of guide vanes, and wherein each guide vane of the plurality of guide vanes is associated with each outlet port of the plurality of outlet ports.

The anti-ice system of one or more of these clauses, wherein the anti-ice air discharged from the outlet port is discharged at an angle to the inner flow surface having a directional component oriented in a downstream direction.

The anti-ice system of one or more of these clauses, wherein the outlet port is structured to discharge the anti-ice air at an angle to the inner flow surface having a directional component oriented in a downstream direction.

The anti-ice system of one or more of these clauses, wherein the shaft side passage is formed in at least two case components that define the flow path.

The anti-ice system of one or more of these clauses, wherein the outlet port is formed in one of the at least two case components.

The anti-ice system of one or more of these clauses, wherein each guide vane of the plurality of guide vanes are pivotable from a first angular flow position to a second angular flow position.

An anti-ice system to provide anti-ice air to a compressor section of a gas turbine engine, the anti-ice system comprising: an annular flow path defined in the compressor section of the gas turbine engine, the annular flow path defined between an inner flow surface and an outer flow surface, the annular flow path structured to convey a working fluid; a plurality of compressor blades arranged in a row and disposed in the annular flow path, the plurality of compressor blades configured to rotate to compress the working fluid; and a plurality of guide vanes arranged in a row and disposed in the annular flow path upstream of the plurality of compressor blades, each guide vane of the plurality of guide vanes extending from a root region to a tip region across the annular flow path, the root region and the tip region located in the annular flow path, the plurality of guide vanes each having an internal cavity and an anti-ice flow passage located at the tip region between the internal cavity and an outer surface of each respective guide vane of the plurality of guide vanes, the anti-ice flow passage having a flow port structured to eject a flow of the anti-ice air, the anti-ice flow passage oriented in a direction having a radial component to impinge the anti-ice air on the inner flow surface of the annular flow path.

The anti-ice system of one or more of these clauses, wherein the anti-ice air is routed from a root region of each guide vane of the plurality of guide vanes to the respective tip region of the guide vane.

The anti-ice system of one or more of these clauses, wherein each guide vane of the plurality of guide vanes includes a leading edge, a trailing edge, and a tip edge having a contour sized to match a contour of an adjacent portion of the inner flow surface of the annular flow path, the tip region having a discharge orifice oriented to impinge the anti-ice air against the adjacent portion of the inner flow surface.

The anti-ice system of one or more of these clauses, wherein each guide vane of the plurality of guide vanes includes a leading edge, the leading edge of each guide vane including a discharge orifice oriented to impinge the anti-ice air in an upstream direction toward an upstream portion of an inner flow path surface of the annular flow path, the direction of the anti-ice flow passage also including an axial component.

The anti-ice system of one or more of these clauses, wherein each guide vane of the plurality of guide vanes are pivotable from a first angular flow position to a second angular flow position.

An anti-ice system to provide anti-ice air to a compressor section of a gas turbine engine, the anti-ice system comprising: an annular flow path defined in the compressor section of the gas turbine engine, the annular flow path defined between an inner flow surface and an outer flow surface, the annular flow path structured to convey a working fluid; a plurality of compressor blades arranged in a row and disposed in the annular flow path, the plurality of compressor blades configured to rotate to compress the working fluid; a row of a plurality of guide vanes positioned in the annular flow path defined by an inner flow surface and an outer flow surface, the plurality of guide vanes each extending from a root region to a tip region across the annular flow path, each guide vane of the plurality of guide vanes having an internal cavity, a leading edge, a tip edge, and a trailing edge, the trailing edge including a discharge port structured to eject a flow of the anti-ice air from the internal cavity, the tip edge including a flow port structured to receive the anti-ice air and an anti-ice flow passage in fluid communication between the internal cavity and the flow port; and a shaft side passage associated with each of the guide vane of the plurality of guide vanes, the shaft side passage located radially inward from the inner flow surface of the annular flow path, the shaft side passage configured to deliver anti-ice air to the flow port.

The anti-ice system of one or more of these clauses, wherein each guide vane of the plurality of guide vanes further includes an internal dam positioned between the root region and the tip edge, the internal dam structured to separate the flow of anti-ice air incoming to the tip region from the shaft side passage and a flow of anti-ice air delivered through the root region of each guide vane to a primary cavity internal to each guide vane.

The anti-ice system of one or more of these clauses, wherein the flow of anti-ice air through the root region originates from the annular flow path at a location downstream of the plurality of guide vanes.

The anti-ice system of one or more of these clauses, wherein the anti-ice air is extracted from a location downstream of the plurality of guide vanes.

The anti-ice system of one or more of these clauses, wherein the flow of anti-ice air through the root region originates from a compression stage of the gas turbine engine.

The anti-ice system of one or more of these clauses, wherein the anti-ice air is extracted from a compression stage of the gas turbine engine.

The anti-ice system of one or more of these clauses, wherein the shaft side passage is in fluid communication with a sump of the gas turbine engine.

The anti-ice system of one or more of these clauses, wherein the discharge port at the trailing edge is in the form of a slot.

An anti-ice system to provide anti-ice air to a compressor section of a gas turbine engine, the anti-ice system comprising: an annular flow path defined in the compressor section of the gas turbine engine, the annular flow path defined between an inner flow surface and an outer flow surface, the annular flow path structured to convey a working fluid, the inner flow surface defined by a component having a shaft side passage; a plurality of compressor blades arranged in a row and disposed in the annular flow path, the plurality of compressor blades or impeller configured to rotate to compress the working fluid; and a plurality of guide vanes arranged in a row and disposed in the annular flow path upstream of the plurality of compressor blades, each guide vane of the plurality of guide vanes extending from a root region to a tip region across the annular flow path, the root region and the tip region located in the annular flow path, the plurality of guide vanes each having an internal cavity and an anti-ice flow passage located at the tip region between the internal cavity and an outer surface of each respective guide vane of the plurality of guide vanes, the anti-ice flow passage having a flow port structured to eject a flow of the anti-ice air, the anti-ice flow passage located proximate the shaft side passage and oriented in a direction having a radial component to convey the anti-ice air onward to the shaft side passage of the component of the inner flow surface and to a region radially inward of the inner flow surface.

The anti-ice system of one or more of these clauses, wherein the shaft side passage is oriented in a direction that includes an axial component, the axial component directed in an upstream direction, the shaft side passage delivering anti-ice air to an upstream location of the inner flow surface.

The anti-ice system of one or more of these clauses, wherein the inner flow surface includes an outlet port located upstream in the annular flow path.

The anti-ice system of one or more of these clauses, wherein each guide vane of the plurality of guide vanes is associated with a respective outlet port.

The anti-ice system of one or more of these clauses, wherein the anti-ice air discharged from the outlet port is discharged at an angle to the inner flow surface having a directional component oriented in a downstream direction.

The anti-ice system of one or more of these clauses, wherein each guide vane of the plurality of guide vanes includes a chord length characterizing an airfoil associated with each guide vane, wherein the outlet port is located no greater than four chord lengths upstream from a leading edge of at least one of the guide vanes of the plurality of guide vanes.

The anti-ice system of one or more of these clauses, wherein the shaft side passage is formed in at least two case components that define the annular flow path.

A method for providing anti-ice air to a compressor section of a gas turbine engine, the method comprising: rotating a compressor rotor having a row of a plurality of compressor blades downstream of a row of a plurality of guide vanes, each guide vane of the plurality of guide vanes including a root region and a tip region; as a result of the rotating, flowing a working fluid through an annular flow path of the gas turbine engine; extracting the anti-ice air from a relatively high pressure and high temperature region of the gas turbine engine; flowing the anti-ice air through an anti-ice flow passage having a flow port in the tip region structured to eject a flow of anti-ice air in a direction having a radial component; and as a result of the flowing, impinging the anti-ice air against an inner flow surface of the annular flow path.

The method of one or more of these clauses, which further includes pivoting each guide vane of the plurality of guide vanes relative to a direction of the working fluid through the annular flow path.

A method for providing anti-ice air to a compressor section of a gas turbine engine, the method comprising: rotating a compressor rotor having a row of a plurality of compressor blades downstream of a row of a plurality of guide vanes, each guide vane of the plurality of guide vanes including a root region and a tip region; as a result of the rotating, flowing a working fluid through an flow path of the gas turbine engine, each guide vane of the plurality of guide vanes disposed in the flow path; extracting the anti-ice air from a relatively high pressure and high temperature region of the gas turbine engine; delivering the anti-ice air to an internal cavity formed in each guide vane of the plurality of guide vanes; and flowing the anti-ice air in a substantially radial direction through the internal cavity over an entirety of the tip region exposed in the flow path.

The method of one or more of these clauses, which further includes pivoting each guide vane of the plurality of guide vanes relative to a direction of the working fluid through the flow path.

The method of one or more of these clauses, which further includes a computing device structured to control a valve, the valve configured to regulate a flow of the anti-ice air to each guide vane of the plurality of guide vanes.

The method of one or more of these clauses, wherein the computing device includes at least one processor and at least one memory device.

The method of one or more of these clauses, wherein the computing device includes a processing device.

The method of one or more of these clauses, wherein the memory device includes information accessible by the at least one processor, the information including computer-readable instructions that can be executed by the at least one processor.

The method of one or more of these clauses, wherein the computing include a network interface.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. An anti-ice system to provide anti-ice air to a compressor section of a gas turbine engine, the anti-ice system comprising:
a flow path defined in the compressor section of the gas turbine engine, the flow path defined between an inner flow surface and an outer flow surface, the flow path structured to convey a working fluid;
a plurality of compressor blades arranged in a row and disposed in the flow path, the plurality of compressor blades configured to rotate to compress the working fluid; and
a plurality of guide vanes arranged in a row and disposed in the flow path upstream of the plurality of compressor blades, each guide vane of the plurality of guide vanes extending from a root region to a tip region across the flow path, the root region and the tip region located in the flow path, the plurality of guide vanes each having an internal cavity and an anti-ice flow passage located at the tip region between the internal cavity and an outer surface of each respective guide vane of the plurality of guide vanes, the anti-ice flow passage having a flow port structured to eject a flow of the anti-ice air, the anti-ice flow passage oriented in a direction having a radial component such that the anti-ice air is flowed in a substantially radial direction through the internal cavity over an entirety of the tip region exposed in the flow path.

2. The anti-ice system of claim 1, wherein the internal cavity extends from the root region of each guide vane of the plurality of guide vanes to a respective tip region of the guide vane, and wherein the anti-ice air is conveyed from the root region to the tip region by the internal cavity.

3. The anti-ice system of claim 1, wherein each guide vane of the plurality of guide vanes includes a leading edge, a trailing edge, and a tip edge having a contour sized to match a contour of an adjacent portion of the inner flow surface of the flow path, the flow port oriented to impinge the anti-ice air against the adjacent portion of the inner flow surface.

4. The anti-ice system of claim 1, wherein the inner flow surface is defined by a component having a shaft side passage; and the plurality of guide vanes each having the internal cavity and the anti-ice flow passage located between the internal cavity and the outer surface of each respective guide vane of the plurality of guide vanes, the flow port structured to eject the flow of the anti-ice air, the anti-ice flow passage located proximate the shaft side passage and oriented to convey the anti-ice air onward to the shaft side passage of the component of the inner flow surface and to a region radially inward of the inner flow surface.

5. The anti-ice system of claim 4, wherein each guide vane of the plurality of guide vanes includes a button, and wherein the anti-ice flow passage is formed in the button.

6. The anti-ice system of claim 4, wherein the shaft side passage is oriented in a direction that includes an axial component, the axial component directed in an upstream direction, the shaft side passage delivering the anti-ice air to an upstream location of the inner flow surface.

7. The anti-ice system of claim 6, wherein an outlet port is located at the upstream location, and wherein the outlet port is configured to emit the anti-ice air into the flow path in a downstream direction.

8. The anti-ice system of claim 4, wherein the inner flow surface includes an outlet port located upstream from the shaft side passage in the flow path.

9. The anti-ice system of claim 8, wherein the outlet port includes a plurality of outlet ports associated with a plurality of shaft side passages in each of the plurality of guide vanes, and wherein each guide vane of the plurality of guide vanes is associated with each outlet port of the plurality of outlet ports.

10. The anti-ice system of claim 9, wherein the outlet port is structured to discharge the anti-ice air at an angle to the inner flow surface having a directional component oriented in a downstream direction.

11. The anti-ice system of claim 9, wherein the shaft side passage is formed in at least two case components that define the flow path.

12. The anti-ice system of claim 11, wherein the outlet port is formed in one of the at least two case components.

13. The anti-ice system of claim 1, wherein each guide vane of the plurality of guide vanes are pivotable from a first angular flow position to a second angular flow position.

14. An anti-ice system to provide anti-ice air to a compressor section of a gas turbine engine, the anti-ice system comprising:
a flow path defined in the compressor section of the gas turbine engine, the flow path defined between an inner flow surface and an outer flow surface, the flow path structured to convey a working fluid;
a plurality of compressor blades arranged in a row and disposed in the flow path, the plurality of compressor blades configured to rotate to compress the working fluid;
a row of a plurality of guide vanes positioned in the flow path defined by the inner flow surface and the outer flow surface, the plurality of guide vanes each extending from a root region to a tip region across the flow path, each guide vane of the plurality of guide vanes having an internal cavity, a leading edge, a tip edge, and a trailing edge, the trailing edge including a discharge port structured to eject a flow of the anti-ice air from the internal cavity, the tip edge including a flow port structured to receive the anti-ice air and an anti-ice flow passage in fluid communication between the internal cavity and the flow port; and
a shaft side passage associated with each of the guide vane of the plurality of guide vanes, the shaft side passage located radially inward from the inner flow surface of the flow path, the shaft side passage configured to deliver the anti-ice air to the flow port.

15. The anti-ice system of claim 14, wherein each guide vane of the plurality of guide vanes further includes an internal dam positioned between the root region and the tip edge, the internal dam structured to separate the flow of the anti-ice air incoming to the tip region from the shaft side passage and a flow of anti-ice air delivered through the root region of each guide vane to a primary cavity internal to each guide vane.

16. The anti-ice system of claim 15, wherein the anti-ice air is extracted from a location downstream of the plurality of guide vanes.

17. The anti-ice system of claim 16, wherein the anti-ice air is extracted from a compression stage of the gas turbine engine.

18. The anti-ice system of claim 14, wherein the shaft side passage is in fluid communication with a sump of the gas turbine engine.

19. The anti-ice system of claim 14, wherein the discharge port at the trailing edge is in a form of a slot.

20. An anti-ice system to provide anti-ice air to a compressor section of a gas turbine engine, the anti-ice system comprising:
a flow path defined in the compressor section of the gas turbine engine, the flow path defined between an inner flow surface and an outer flow surface, the flow path structured to convey a working fluid, the inner flow surface defined by a component having a shaft side passage;
a plurality of compressor blades arranged in a row and disposed in the flow path, the plurality of compressor blades configured to rotate to compress the working fluid; and
a plurality of guide vanes arranged in a row and disposed in the flow path upstream of the plurality of compressor blades, each guide vane of the plurality of guide vanes extending from a root region to a tip region across the flow path, the root region and the tip region located in the flow path, the plurality of guide vanes each having an internal cavity and an anti-ice flow passage located at the tip region between the internal cavity and an outer surface of each respective guide vane of the plurality of guide vanes, the anti-ice flow passage including a flow port oriented to eject the anti-ice air in an upstream direction toward an upstream portion of an inner flow path surface of the flow path.
